(19) United States
(12) Patent Application Publication
(10) Pub. No.: US 2014/0365889 A1
(43) Pub. Date: Dec. 11, 2014

(54) USER EFFECTED ADAPTIVE STREAMING

(71) Applicants: Justin Lipman, Shanghai (CN); Akshay Chandrasekhar, Bangalore (IN)

(72) Inventors: Justin Lipman, Shanghai (CN); Akshay Chandrasekhar, Bangalore (IN)

(21) Appl. No.: 13/996,461

(22) PCT Filed: Dec. 28, 2011
(86) PCT No.: PCT/CN11/84784

§ 371 Date: Aug. 19, 2014

(51) Int. Cl. H04L 29/06; G06F 3/0484; G06F 3/0485; G06F 3/0481

(52) U.S. Cl. CPC H04L 65/601; G06F 3/0481; G06F 3/04842; G06F 3/04847; G06F 3/04855
USPC 715/719; 715/753

(57) ABSTRACT

Methods, apparatuses and storage medium associated with multi-media streaming with user effected adaptation are disclosed. In various embodiments, a method may include receiving, by a device, streaming of a multi-media content from a multi-media server, and determining, by the device, current multi-media streaming context of the device. The method may further include providing, by the device, a user control for a user of the device to effect adaptation of the streaming of the multi-media content. The user control may include a plurality of control selections having associated qualitative descriptions of the control selections. Other embodiments may be disclosed or claimed.

### TECHNICAL FIELD

This application relates to the technical field of data processing, more specifically to methods and apparatuses associated with user effected adaptive streaming.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Existing web based multi-media streaming methods often require a user to use one of the following default resolutions (240p, 360p, 420p, 720p etc) for streaming and viewing the multi-media content. As a result, streaming of the multi-media content often defaults to either a website's default or the lowest common denominator (in the case of streaming for multi-users). If improving the streaming is desired, typically, a user must manually select a lower or higher resolution (if available). Further, adjustment of resolution is typically made through an unfriendly form type interface. Additionally, the user typically makes the adjustment without knowledge of the streaming context, such as available bandwidth, what resolution will provide good quality, and so forth. Thus, the user will typically make the adjustment on a trial and error basis. For example, make an adjustment, then observe whether the streaming progress bar suggests the content is being received faster than playback, if not, make another adjustment, and repeat the process. However, the average user often does not always understand this process, thus an average user will often simply pause the media player, go do something else, and return at sometime later when the higher quality stream has been received. The end result is generally poor and frustrating user experience in consuming multi-media content.

There are commercial streaming mechanisms for automatically adjusting the streaming given detected available bandwidth. However, these mechanisms typically remove the user and their requirements from the equation, thus also can provide a frustrating user experience, especially if the user is willing to use a lower quality stream (e.g., when quickly scanning or reviewing some multi-media). Further, the server side typically has no knowledge of the resulting “window” size being used to display the multi-media content on the client device. Hence streamed content is often not scaled for the display unit of the client device. Users are often forced to use a set window size.

The above problems are also evident in existing single/multi-user video conferencing and social networking videoconferencing. A user is typically unable to selectively adjust their viewing experience in view of their own streaming context. Further, in multi-user meeting/conference situations, a user is unable to increase the quality of one stream over other streams (e.g., viewing more clearly the current speaker or a whiteboard, and less clearly for other people in the meeting).

### BRIEF DESCRIPTION OF THE DRAWINGS

Embodiments of the present invention will be described by way of exemplary embodiments, but not limitations, illustrated in the accompanying drawings in which like references denote similar elements, and in which:

FIG. 1 illustrates an example client device configured to render adaptively streamed multi-media content with its user enabled to effect the adaptive streaming;

FIGS. 2 and 3 illustrate example user interfaces for the user to effect the adaptive streaming;

FIG. 4 illustrates a method for user effected adaptive streaming; and

FIG. 5 illustrates an example non-transitory computer-readable storage medium having instructions configured to practice all or selected aspects of the method of FIG. 4; all arranged in accordance with embodiments of the present disclosure.

### DETAILED DESCRIPTION

Methods, apparatuses and storage medium associated with multi-media streaming with user effected adaptation are disclosed. In various embodiments, a method may include receiving, by a device, streaming of a multi-media content from a multi-media server, and determining, by the device, current multi-media streaming context of the device. The method may further include providing, by the device, a user control for a user of the device to effect adaptation of the streaming of the multi-media content. The user control may include a plurality of control selections having associated qualitative descriptions of the control selections. Other embodiments may be disclosed or claimed.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Various operations will be described as multiple discrete operations, in turn, in a manner that is most helpful in understanding the illustrative embodiments; however, the order of description should not he construed as to imply that these operations are necessarily order dependent. In particular, these operations need not be performed in the order of presentation. Further, descriptions of operations as separate operations should not be construed as requiring that the operations be necessarily performed independently and/or by separate entities. Descriptions of entities and/or modules as separate modules should likewise not be construed as requiring that the modules be separate and/or perform separate operations. In various embodiments, illustrated and/or described operations, entities, data, and/or modules may he merged, broken into further sub-parts, and/or omitted.

The phrase “in one embodiment” or “in an embodiment” is used repeatedly. The phrase generally does not refer to the same embodiment; however, it may. The terms “comprising,” “having,” and “including” are synonymous, unless the context dictates otherwise. The phrase “A/B” means “A or B”. The phrase “A and/or B” means “(A), (B), or (A and B)”. The phrase “at least one of A, B and C” means “(A), (B), (C), (A and B), (A and C), (B and C) or (A, B and C)”.

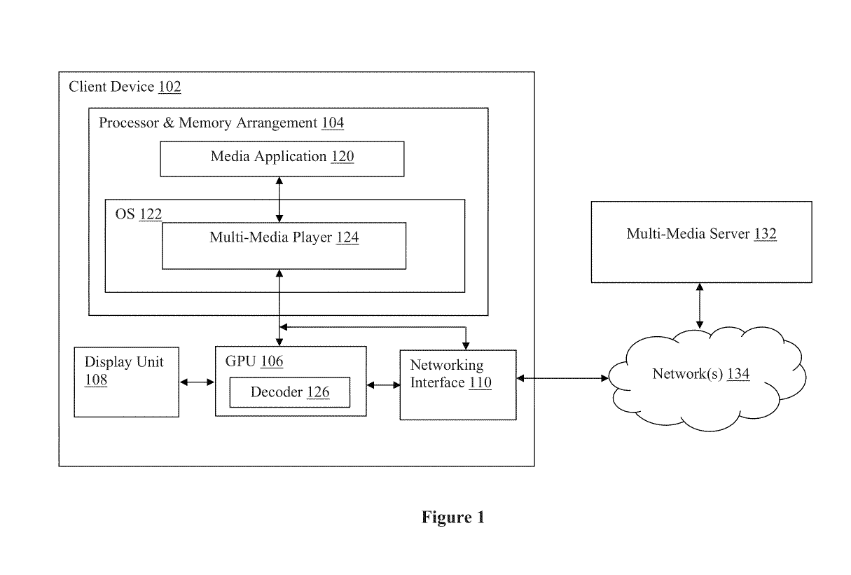

FIG. 1 illustrates an example client device configured to render adaptively streamed multi-media content with its user enabled to effect the adaptive streaming, in accordance with various embodiments of the present disclosure. As shown, for the illustrated embodiments, client device 102 may be coupled with, and receiving multi-media content streamed from multi-media server 132, through network(s) 134. Client device 102 may include processor and memory arrangement 104 configured to have operating system (OS) 122 and media application 120 operated therein, graphics processing unit (GPU) 106 (with decoder 126), display unit 108, and networking interface 110. Further, OS 122 may include multi-media player 124. In various embodiments, client device 102 may be a desktop computer, a laptop computer, a tablet computer, a smartphone, a personal digital assistant or a game console. Thus, client device 102 may also be referred to as client computing device or simply, computing device.

In various embodiments, multi-media player 124 may be configured to render streamed multi-media content on display unit 108, through GPU 106. Multi-media player 124 may be configured to cooperate with multi-media server 132 to enable the multi-media content to be adaptive streamed. Cooperation may include determining the streaming context, which may include available bandwidth of a network connection between client device 102 and multi-media server 132, the processing capability of the GPU 106 (including decoding capability of an embedded or external decoder), the processing capability of processor and memory arrangement 104, the display capability (e.g., screen size) of display unit 108, and so forth. Cooperation may further include providing the determined information, and/or configuration information of the device to the server. Further, cooperation may include jointly arriving with the server the operation parameters of the streaming, such as resolution, color depth, encoding and/or compression scheme, bit rate, and an forth. Additionally, multi-media player 124 may be configured to provide a user control feature to enable a user to effect the adaptive streaming. As will be described in more detail below, the user control feature may be in view of the determined streaming context, and may include features that assist the user in effecting the adaptive streaming, thus potentially providing a better user experience in consuming the streamed multi-media content. Multi-media player 124 (except for the earlier described aspects) is otherwise intended to represent a broad range of media players known in the art.

In various embodiments, as described earlier, processor and memory arrangement 104 may be configured to enable OS 122, including multi-media player 124, and media application 120 to be operated therein. Processor and memory arrangement 104 is intended to represent abroad range of processor and memory arrangement, including but are not limited to arrangements with single or multi-core processors of various execution speeds and power consumptions, and memory of various architectures with one or more levels of caches, and of various types, dynamic random access, FLASH, and so forth.

In various embodiments, GPU 106 (with decoder 126) may be configured to provide video decoding and/or graphics processing functions to OS 122 and/or media application 120, through multi-media player 124, white display unit 108 may be configured to enable multi-media content, e.g., HD video, to be rendered thereon. Examples of graphics processing functions may include, but are not limited to, transform, lighting, triangle setup/clipping, polygon processing, and on forth.

OS 122 (except for multi-media player 124) and media application 120 are intended to represent a broad range of these elements known. Examples of OS 122 may include, but are not limited to Windows® operating systems, available from Microsoft Corporation of Redmond, Wash., Linux, available from e.g., Red Hat of Raleigh, N.C., Android™ developed by the Open Handset Alliance, or IOS, available from Apple Computer of Cupertino, Calif. Examples of media application 120 may include, but are not limited to, videoconferencing applications, or generic application agents, such as a browser. Examples of a browser may include, but are not limited to, Internet Explorer, available from Microsoft Corporation of Redmond, Wash., or Firefox, available from Mozilla of Mountain View, Calif.

Similarly, multi-media server 132 and network(s) 134 are intended to represent a broad range of these elements known. Examples of multi-media server 132 may include, but are not limited to, a video server from Netflix, Inc, of Los Gatos, Calif., or a video server from CNN of Atlanta, Ga. Network(s) 134 may include wired or wireless, local or wide area, private or public networks, including the Internet.

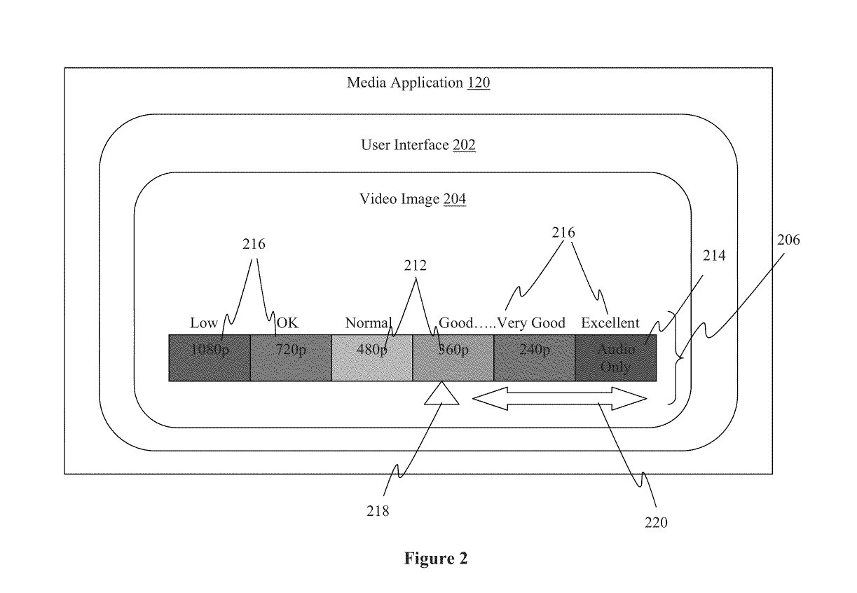

Referring now to FIG. 2, wherein illustrated is an example user interface 202 having a user control feature 206 for a user to effect adaptive streaming of multi-media content, in accordance with various embodiments of the present disclosure. In various embodiments, as described earlier, user control feature 206 may be provided for media application 120 by multi-media player 124. In particular, user control feature 206 may be provided after multi-media player 124 making a determination of the streaming context of client device 102. In alternate embodiments, user control feature 206 may be provided by other components or media application 120 itself.

As illustrated, in various embodiments, media application 120 may include user interface 202 for rendering video images 204 of an adaptively streamed multi-media content. Further, user interface 202 may include user control feature 206 to enable a user to effect the adaptive streaming. In various embodiments, user control feature 206 may include a number of control selections 212 (e.g., resolutions 1080p, 720p, 480p, 360p and/or 240p) for the user to select and control the adaptive streaming. In alternate embodiments, control selections may be e.g., 32 bit color depth, 24 bit color depth, 16 bit color depth, 256 colors, and/or monochrome, instead. Further, user control feature 206 may include a control selection of “audio only” 214, whereby streaming of video images will be halted. Additionally, in various embodiments, control selections 212 may have corresponding qualitative descriptions (e.g., “Low,” “OK,” “Normal,” “Good,” “Very Good,” and/or “Excellent” in terms of the overall quality of the audio/video rendering) to assist the user in selecting one of the control selections, accounting for the possibility that the user might be a non-technical user and not having full appreciation of the resolution or other control selections. User control feature 206 may also include a colored background 216 having a continuous spectrum of different shades of different color (e.g., from dark red, medium dark red, light red, light green, medium dark green to light green) to further assist the user in selecting one of the control selections. In alternate embodiments, background 216 may be a continuous spectrum of grayscales instead.

In various embodiments, user control feature 206 may be presented in the form of a slider, with a slidable feature 218, using e.g., a cursor control device or finger/stylus (in the case of touch sensitive screens), for the user to make selection. User control feature 206 may also include recommendation indicator 220 to recommend to the user with respect to which control selection or selections to select.

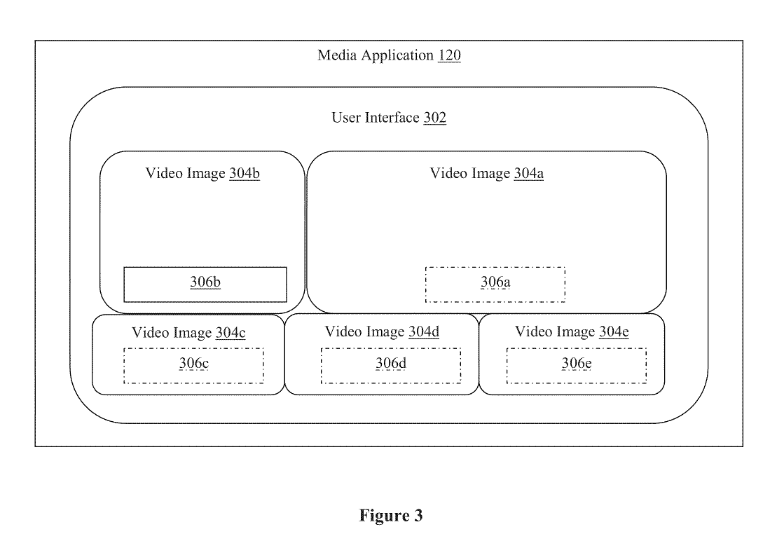

FIG. 3 illustrates another example user interface 302 having multiple images 304a-304e of multiple streams, with respective multiple user control features 306a-306e, one for each video image, for a user to selectively and individually effect adaptive streaming of the different streams, in accordance with various embodiments of the present disclosure. As shown, video images 304a-304e of the different streams may be provided with respective user control features 306a-306e for the user to selectively and individually effect adaptive streaming of the different streams. Each of user control features 306a-306e may be an instantiation of the earlier described user control feature 206 or variants thereof. In various embodiments, user control features 306a-306e may be hidden (as denoted by the dash boundary lines), and provided on demand (as denoted by the solid boundary line in the case of 306b). In various embodiments, multi-media player 124 may be configured to enable a user to request for the corresponding user control feature for a video image 304a-e, e.g., by moving a cursor over a predetermined area of the video image 304a-e using a cursor control device, by right clicking with the cursor control device white over the video image 304a-e, by sensing a user movement (e.g., finger) in the case of touch sensitive screen, or by other means of the like.

In various embodiments, as described earlier, media application 120 may be a video conferencing application. Accordingly, video images 304a-e may be images of various participants of a videoconference. Thus, with respective user control features 306a-306e, a user may selectively and individually control the adaptive streaming of different conference participants, e.g., favoring one or a subset of the conference participants over other conference participants.

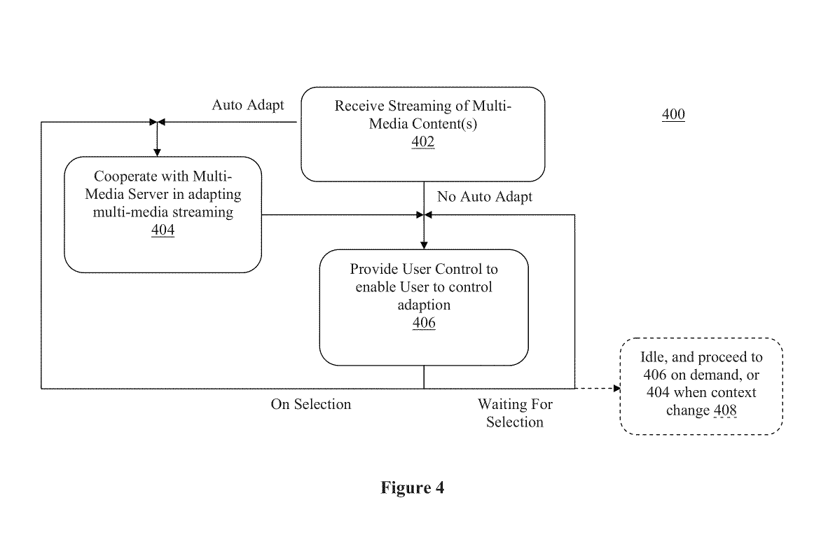

FIG. 4 illustrates a method for user effected adaptive streaming, in accordance with various embodiments of the present disclosure. As illustrated, method 400 may begin at block 402, At block 402, multi-media player 124 may receive and render (or begin to receive and render) one or more streams of multi-media content. From block 402, method 400 may proceed to block 406 or to block 404, before proceeding to block 406.

At block 404, multi-media player 124 may cooperate with multi-media server 132 in adapt streaming the multi-media content. As described earlier, as part of the cooperation, multi-media player 124 may determine the streaming context of client device 102. From block 404, method 400 may proceed to block 406.

At block 406, multi-media player 124 may provide user control feature 206/306a-e for a user to effect adaptive streaming as earlier described. If method 400 arrives at block 406 without having first passing through block 404, multi-media player 124 may likewise first make a determination of the streaming context of client device 102, before providing the user control feature. At block 406, method 400 may remain there and await the user in making a selection of the presented control selections. On receipt of a user selection, method 400 may proceed/return to block 404, wherein multi-media player 124 may cooperate with multi-media server 132 to (further) adapt streaming of the multi-media content, in view of the streaming context of client device 102 and the user selection. Thereafter, method 400 may proceed to block 406 again, and continue operation therefrom.

In alternate embodiments, after looping for a period of time waiting for user selection, method 400, in lieu of continuing looping at block 406, may optionally proceed to block 408 instead (as denoted by the dash lines). At block 408, method 400 may enter an idle state with user control feature 206/306a-e hidden. From block 408, method may then proceed to either block 406 again, in response to a user request for the user control feature 206/306a-e as described earlier, or to block 404 again, in response to a change in the streaming context, e.g., change in bandwidth, change in device workload, and so forth. On return to block 404, method 400 may again first adapt the streaming in view of the changed context, e.g., changing resolution, changing color depth (including changing from color to monochrome), and then proceed to block 406 again to provide with the user a means to effect the adaptation, as earlier described.

Accordingly, better user experience in consuming streamed multi-media content potentially may be had.

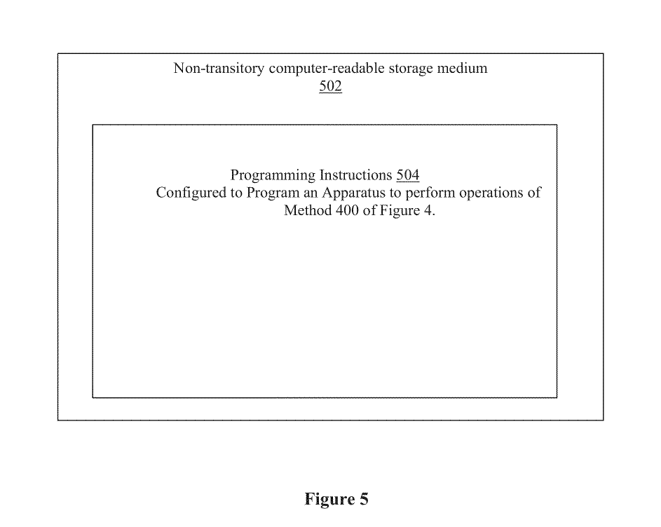

FIG. 5 illustrates an example non-transitory computer-readable storage medium having instructions configured to practice all or selected aspects of the method of FIG. 4; in accordance with various embodiments of the present disclosure. As illustrated, non-transitory computer-readable storage medium 502 may include a number of programming: instructions 504. Programming instructions 504 may be configured to enable a computing device, e.g. client device 102, in response to execution of the programming instructions, to perform multi-media player operations of method 400 earlier described with references to FIG. 4. In alternate embodiments, programming instructions 504 may be disposed on multiple non-transitory computer-readable storage media 502 instead.

Referring back to FIG. 1, for one embodiment, at least one of the processor(s) of processor and memory arrangement 104 may be packaged together with computational logic of multi-media player 124 configured to practice the method of FIG. 4. For one embodiment, at least one of the processor(s) of processor and memory arrangement 104 may be packaged together with computational logic of multi-media player 124 configured to practice the method of FIG. 4 to form a System in Packacze (SiP). For one embodiment, at least one of the processor(s) of processor and memory arrangement 104 may be integrated on the same die with computational logic of multi-media player 124 configured to practice the method of FIG. 4. For one embodiment, at least one of the processor(s) of processor and memory arrangement 104 may be integrated on the same die with computational logic of multi-media player 124 configured to practice the method of FIG. 4 to form a System on Chip (SoC). For at least one embodiment, the SoC may be utilized in a smartphone, a computing tablet, or other mobile devices.

Although specific embodiments have been illustrated and described herein, it will be appreciated by those of ordinary skill in the art that a wide variety of alternate and/or equivalent implementations may be substituted for the specific embodiments shown and described, without departing from the scope of the embodiments of the present disclosure, This application is intended to cover any adaptations or variations of the embodiments discussed herein, Therefore, it is manifestly intended that the embodiments of the present disclosure be limited only by the claims and the equivalents thereof.

1. At least one computer-readable storage medium having instructions configured to enable a device, in response to execution of the instruction, to:
receive streaming of a multi-media content from a multi-media server;
determine current multi-media streaming context of the device; and
provide a user control for a user of the device to effect adaptation of the streaming of the multi-media content, wherein the user control comprises a plurality of control selections having associated qualitative descriptions of the control selections.

2. The at least one computer-readable storage medium of claim 1, wherein determine comprises determine at least one of a current bandwidth of a networking connection, decoding capability of a decoder of the device, processing capability of a graphics processing unit of the device, processing capability of a processor of the device, or a screen size of a display unit of the device.

3. The at least one computer-readable storage medium of claim 1, wherein provide a user control comprises provide a user control wherein the plurality control selections comprise a plurality of resolution or color depth selections having associated qualitative descriptions.

4. The at least one computer-readable storage medium of claim 3, wherein the plurality of resolution selections comprises one or more of 1080p, 720p, 480p, 360p or 240p.

5. The at least one computer-readable storage medium of claim 3, wherein the plurality of color depths comprise one or more of 32 bit color depth, 24 bit color depth, 16 bit color depth, 256 bit color depth, or monochrome.

6. The at least one computer-readable storage medium of claim 1, wherein provide a user control comprises provide a user control wherein the user control further comprises a colored background to complement the control selections, wherein the colored background comprises a continuous spectrum of a plurality of shades of a plurality of colors or grayscale.

7. The at least one computer-readable storage medium of claim 6, wherein the plurality of colors comprise one or more of a red color or a green color.

8. The at least one computer-readable storage medium of claim 1, wherein provide a user control comprises provide a user control wherein the plurality control selections comprise associated qualitative descriptions of audio/video quality that include one or more of “Excellent,” “Very Good,” “Good,” “Normal,” “OK,” or “Low.”

9. The at least one computer-readable storage medium of claim 1, wherein provide a user control comprises provide a user control in a form of a slider that allows the user to use a cursor control unit of the device to slide from one control selection to another to select one of the control selections.

10. The at least one computer-readable storage medium of claim 1, wherein provide a user control comprises provide a user control, wherein the user control further comprises a recommendation on which of the control selections to select.

11. The at least one computer-readable storage medium of claim 1, wherein the multi-media content comprises video and audio content, and provide comprises provide the user control, wherein the user control further comprises a control to adjust the streaming to stream monochrome video or only the audio content.

12. The at least one computer-readable storage medium of claim 1, wherein the instructions further enable the device, in response to execution of the instructions, to provide configuration or performance information to the multi-media server to enable the multi-media server to adaptively stream the multi-media content.

13. The at least one computer-readable storage medium of claim 1, wherein receive comprises receive streaming of at least one other multi-media content, and provide comprises provide the user control for each of the multi-media contents for the user to individually control streaming of the multi-media contents.

14. The at least one computer-readable storage medium of claim 13, wherein the multi-media contents are multi-media contents of a videoconference, or wherein provide comprises provide the user control to each of the multi-media contents on demand or on detection of a cursor or a user movement.

15. A method for user effected adaptive streaming of multi-media content, comprising:
receiving, by a device, streaming of a multi-media content from a multi-media server;
determining, by the device, current multi-media streaming context of the device; and
providing, by the device, a user control for a user of the device to effect adaptation of the streaming of the multi-media content, wherein the user control comprises a plurality of control selections having associated qualitative descriptions of the control selections.

16. (canceled)

17. (canceled)

18. (canceled)

19. (canceled)

20. (canceled)

21. (Canceled)

22. (Canceled)

23. (Canceled)

24. (Canceled)

25. (Canceled)

26. The method of claim 15 further comprising providing, by the device, configuration or performance information to the multi-media server to enable the multi-media server to adaptively stream the multi-media content.

27. (canceled)

28. (canceled)

29. An apparatus for user effected adaptive streaming of multi-media content comprising:
a processor and memory arrangement; and
a multi-media player configured to be operated by the processor and memory arrangement to
receive streaming of a multi-media content from a multi-media server;
determine current multi-media streaming context of the apparatus; and
provide a user control for a user of the apparatus to effect adaptation of the streaming of the multi-media content, wherein the user control comprises a plurality of control selections having associated qualitative descriptions of the control selections.

30. The apparatus of claim 29, wherein the multi-media player is configured to determine, for the current multi-media streaming context, at least one of a current bandwidth of a networking connection, decoding capability of a decoder of the apparatus, processing capability of a graphics processing unit of the apparatus, processing capability of a processor of the apparatus, or a screen size of a display unit of the apparatus.

31. The apparatus of claim 29, wherein the multi-media player is configured to provide the user control wherein the plurality control selections comprise a plurality of resolution or color depth selections having associated qualitative descriptions.

32. The apparatus of claim 31, wherein the plurality of resolution selections comprises one or more of 1080p, 720p, 480p, 360p or 240p.

33. The apparatus of claim 31, wherein the plurality of color depths comprise one or more of 32 bit color depth, 24 bit color depth, 16 bit color depth, 256 bit color depth, or monochrome.

34. The apparatus of claim 29, wherein the multi-media player is configured to provide the user control wherein the user control further comprises a colored background to complement the control selections, wherein the colored background comprises a continuous spectrum of a plurality of shades of a plurality of colors or grayscale.

35. The apparatus of claim 34, wherein the plurality of colors comprise one or more of a red color or a green color.

36. The apparatus of claim 29, wherein the multi-media player is configured to provide the user control in a form of a slider that allows the user to use a cursor control unit of the apparatus to slide from one control selection to another to select one of the control selections.

37. The apparatus of claim 29, wherein the multi-media player is configured to provide the user control, wherein the user control further comprises a recommendation on which of the control selections to select.

38. The apparatus of claim 29, wherein the multi-media player is configured to receive streaming of at least one other multi-media content, and provide comprises provide the user control for each of the multi-media contents for the user to individually control streaming of the multi-media contents.

39. The apparatus of claim 38, wherein the multi-media contents are multi-media contents of a videoconference, or wherein the multi-media player is configured to provide the user control to each of the multi-media contents on demand or on detection of a cursor or user movement.

40. (canceled)
